(19) United States
(12) Patent Application Publication
(10) Pub. No.: US 2008/0203624 A1
(43) Pub. Date: Aug. 28, 2008

(54) Tubing Manufacture

(75) Inventor: John Angus Dunn, Rosneath (GB)

Correspondence Address: FOLEY AND LARDNER LLP;SUITE 500, 3000 K STREET NW, WASHINGTON, DC, 20007, US

(73) Assignee: Smiths Group PLC

(21) Appl. No.: 12/071,709

(22) Filed: Feb. 25, 2008

(30) Foreign Application Priority Data
Feb. 27, 2007 (GB) 0703704.7

(51) Int. Cl. B29C 55/28

(52) U.S. Cl. 264/565; 425/387.1

(57) ABSTRACT

Apparatus for vulcanising and corrugating rubber tubing includes a mold with a corrugated inner surface. The mold is heated by electrical resistance heating elements. A length of uncured straight tubing is placed in the mold and its external surface is forced into contact with the corrugated mold surface by the combination of a positive gas pressure within the tubing and a negative gas pressure outside the tubing. The tubing is maintained in the heated mold for long enough for it to be vulcanised and take the internal shape of the mold.

### BACKGROUND OF THE INVENTION

This invention relates to apparatus and methods of manufacturing tubing.

The invention is more particularly concerned with the manufacture of tubing of a rubber or similar vulcanisable material.

Rubber tubing is conventionally made by placing an uncured length of rubber tubing on a mandrel or former and then placing the assembly of the tube and former in a steam autoclave or oven for a predetermined time sufficient for the tube to become vulcanised or cured. Corrugated or other profiled rubber tubing can be made in a similar way by placing a length of uncured, uncorrugated tubing on an externally corrugated former and applying force to the tubing so that it is pushed into the valleys between the corrugations. Usually, this is achieved by wrapping a cord or the like tightly around the outside of the tubing. After vulcanising in the autoclave or oven, the assembly is then removed and the corrugated tube is stripped from the former, which can then be used again. This process has several disadvantages in that it is relatively lengthy, it involves considerable manual handling, it is not suited to automation, and the size of the autoclave or oven limits the maximum length of tubing that can be made.

Examples of arrangements for making tubing are described in GB651097, GB1041351, U.S. Pat. No. 2,909,198, U.S. Pat. No. 3,155,757, GB547751, GB593068, GB647084, GB652810, GB551499, U.S. Pat. No. 4,053,275, U.S. Pat. No. 4,113,828, U.S. Pat. No. 3,168,604, U.S. Pat. No. 3,304,581, U.S. Pat. No. 3,669,586, WO07/063260, JP2004150474, EP488635, U.S. Pat. No. 4,360,493, JP2004322583 and U.S. Pat. No. 5,525,288.

There are many examples of manufacturing processes suitable for continuously producing corrugated or ribbed thermoplastic tubing. This material is more suited to continuous manufacture because it can be extruded and formed to any desired shape while warm or by subsequent heating. The tubing rapidly sets in this shape when its temperature falls. The problem, however, with rubber materials is that they only take a permanent shape after vulcanisation.

### BRIEF SUMMARY OF THE PRESENT INVENTION

It is an object of the present invention to provide an alternative apparatus and method of making tubing of a rubber material.

According to one aspect of the present invention there is provided apparatus for vulcanising uncured tubing of a rubber material including external mold means provided with a surface for contacting the external surface of the tubing, means for forcing the tubing into contact with the surface of the mold means, and means for heating the mold means such that the tubing is heated while in contact with the mold means for sufficient time for the rubber material to vulcanise.

The contacting surface of the mold means is preferably provided with surface formations corresponding to the external shape of the surface formations to be formed on the tubing, The surface formations on the mold means are preferably corrugations such that the tubing is formed with a corrugated shape. The means for forcing the tubing onto contact with the surface formations on the mold preferably includes by gas pressure means. The gas pressure means may include means for generating a negative pressure outside the tubing. The gas pressure means may include means for generating a positive pressure inside the tubing. The heating means may include electrical resistance heating means associated with the mold means. The apparatus may include means for displacing the uncured rubber tubing along its length, the mold means being provided by a plurality of molds arranged in a continuous loop that is moved with the tubing as it is displaced. The means for displacing the tubing is preferably an extruder.

According to another aspect of the present invention there is provided a method of making tubing of a rubber material including providing smooth-walled tubing of an uncured rubber material, contacting the external surface of the tubing with a mold surface, heating the tubing while it is contacted by the mold surface, maintaining the tubing at a sufficient temperature and maintaining contact with the mold surface for a sufficient time that the tubing becomes vulcanised.

The mold surface is preferably profiled, the external surface of the tubing being forced into contact with the profiled mold surface such that the tubing takes the shape of the mold surface. The method may include the step of applying gas pressure to force the external surface of the tubing into contact with the mold surface. The method may include the step of moving the tubing along its length as it is vulcanised.

According to a further aspect of the present invention there is provided tubing made by apparatus according to the above one aspect or by a method according to the above other aspect of the present invention.

Apparatus for making corrugated rubber tubing and its method of operation, will now be described, by way of example, with reference to the accompanying drawings.

### BRIEF DESCRIPTION OF THE DRAWINGS

FIG. 1 shows schematically a first form of the apparatus for batch production; and

FIG. 2 shows schematically a second form of the apparatus for continuous production.

### DETAILED DESCRIPTION OF THE PREFERRED EMBODIMENTS

The apparatus includes a number of pairs of mold blocks 32 arranged in a straight row. The mold blocks 32 are of a robust, rigid material, such as a metal and have a semicircular surface 34 with an undulating surface formation or profile of parallel hills 35 and valleys 36 corresponding to the formation of the desired corrugations on the tubing 2. Different shape mold blocks could be used with tubing of different section. Also, it will be appreciated, that the mold blocks need not be provided in pairs but could, for example, be provided in other shapes such as groups of three with mold surfaces extending around approximately 120° each. The blocks 32 are arranged so that the profiled surfaces 34 are presented inwardly. Each mold block 32 includes at least one gas passage 37 extending through the thickness of the mold block from the profiled surface 34 to its opposite surface where it communicates with a vacuum pump 38. The gas passage 37 extends from a lower part of a valley 36 on the profiled surface 34. Preferably, a separate gas passage may open into each valley 36, the passages communicating with one another at the rear surface of the block 32. Each block 32 also includes a heater 40, such as an electrical resistance heating element enclosed within the block effective to heat at least the forward, profiled surface 34.

A preformed length of uncured, vulcanisable tubing 2, such as of a rubber is inserted between the mold blocks 32. The uncured tubing 2 is preferably extruded by an extruder (not shown) and is cut to length. The apparatus also includes some means 50 to apply a positive air pressure to the interior of the tubing 2 such as via a central mandrel (not shown), which is a close sliding fit within the tubing 2. This positive, internal air pressure may not be needed if sufficient negative pressure can be applied via the vacuum passages 37. It may be necessary to block the end of the tubing 2 if positive internal pressure is used. Preferably, the air supplied in either arrangement is heated.

In operation, the negative pressure applied via the gas passages 37 and the positive, internal air pressure force the tubing 2 radially outwardly against the profiled surfaces 34 of the mold blocks 32. The pressure is sufficient, with the tubing 2 in an uncured state, for it to be expanded and forced into the valleys 36 and around the hills 35 to take up the shape of the profile 34 of the mold blocks 32, both on the outside and inside surfaces of the tubing. The mold blocks 32 are heated by the heaters 40 sufficiently to raise the temperature of the tubing 2 to a vulcanising temperature in the range of about 130° C. to 200° C., preferably about 180° C. The time for which the tubing 2 is maintained in the mold blocks 32 is selected to be sufficient, given the vulcanisation system used in the material and the temperature of the mold blocks, for the tubing to become vulcanised.

The profile on the mold blocks 32 is selected to provide a series of parallel, non-communicating corrugations of rounded shape. Alternative shapes could be used. For example, the mold profiles could be selected to give one or more helical undulations along the tube. It will be appreciated that the apparatus could be used to vulcanise smooth-walled tubing by using mold blocks with a smooth tube-contacting surface. In such an arrangement it would not be necessary to use gas pressure to bring the mold surface into close contact with the tube since pressure applied by the mold blocks to the outside of the tube could be sufficient. The apparatus could be used to form any similar tubular product from a thermosetting rubber, such as, for example, bellows. The mold blocks include flat regions to form uncorrugated sections at intervals along the tubing, which could be cut to provide cuffs at the ends of lengths of tubing. The tubing need not have a circular section but could, for example, be oval.

Various modifications to the apparatus are possible. For example, instead of using electrical heating elements in the mold blocks they could be heated, such as by radiation heating, hot gas, induction heating or the like. The invention could be used with any thermosetting rubber, or rubber-like material. It is possible that the tubing could be forced against the profiled surface of the mold blocks in ways other than by negative or positive gas pressure, such as by means of an expandable, profiled internal mandrel.

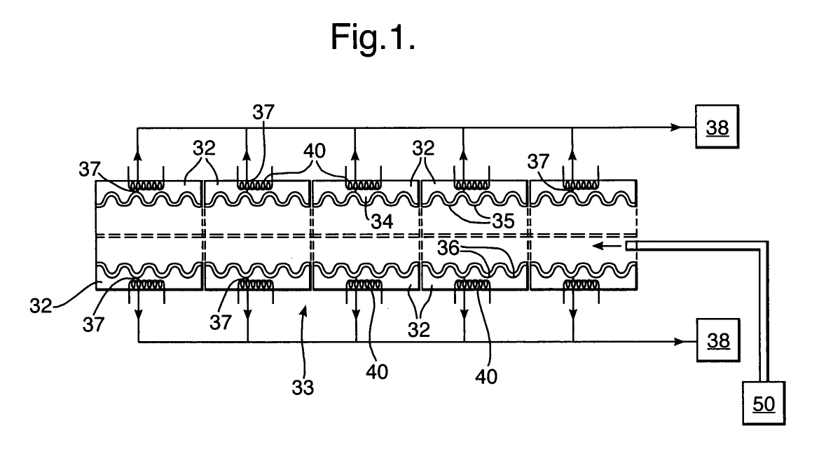

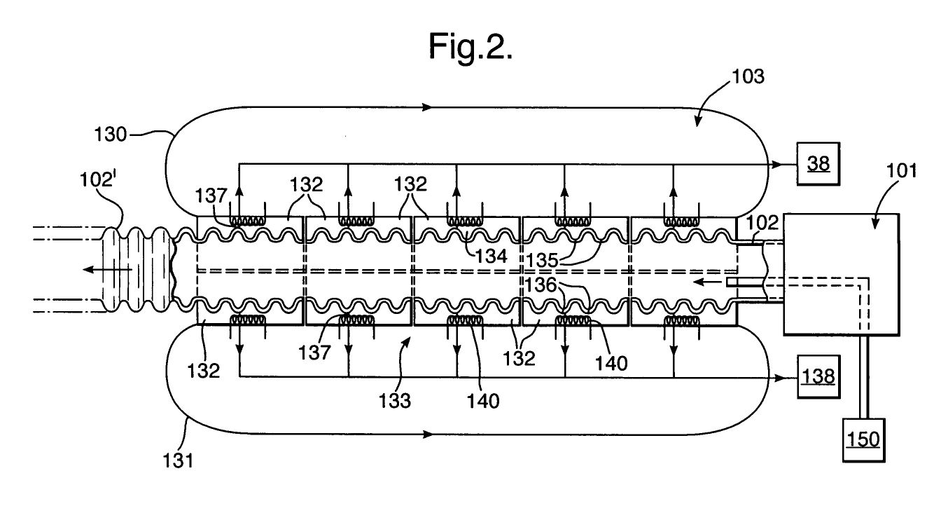

In the arrangement described above, the tubes are formed by a batch process. The invention can, however, readily be applied to a continuous process as shown in the apparatus of FIG. 2, in which components equivalent to those in the arrangement of FIG. 1 are given the same reference numerals with the addition of 100.

The apparatus includes a rubber extrusion machine 101 arranged to extrude a continuous length of smooth-walled (uncorrugated), uncured thermosetting rubber tubing 102 of circular section. As shown, the tubing 102 emerges from the left-hand side of the machine 101 and is displaced by the extruder to move from right to left. A corrugation machine 103 is located immediately adjacent the outlet of the extrusion machine 101. This comprises a continuous upper and lower trackway 130 and 131 formed of multiple pairs of heated mold blocks 132.

The blocks 132 are linked to a motor (not shown) so as to be driven continuously in a loop, including a central, straight, forming section 133 extending parallel with the path along which the tubing 102 emerges from the extrusion machine 101. The mold blocks 132 are of the same kind as described with reference to FIG. 1. The mold blocks 132 are moved along the trackways 130 and 131 from right to left along the forming section 33, at the same speed and in the same direction as the tubing 102 emerges from the extrusion machine 101. When the blocks 132 reach the extreme left-hand end of the forming section 133, they are then lifted away from the tubing 102 and are moved in the opposite direction, from left to right, back to the start of the forming section.

The apparatus also includes some means 150 to apply a positive air pressure to the interior of the tubing 102 during its passage along this forming section 133. The air pressure could be supplied via a nozzle in the extrusion machine 101 arranged centrally of the tubing.

In operation, tubing 102 emerges from the extrusion machine 101 in an uncured state and with smooth walls. As the tubing 102 passes through the forming section 133, the negative pressure applied via the gas passages 137 and the positive, internal air pressure force the tubing radially outwardly against the profiled surfaces 134 of the mold blocks 132. The pressure is sufficient, with the tubing 102 in an uncured state, for it to be forced into the valleys 136 and around the hills 135 to take up the shape of the profile 134 of the mold blocks 132, both on the outside and inside surfaces of the tubing. The mold blocks 132 are heated by the heaters 140 sufficiently to raise the temperature of the tubing 102 in the manner described above. The time taken for the tubing 102 to pass through the forming section 133 is selected to be sufficient, given the vulcanisation system used in the material and the temperature of the mold blocks 132, for the tubing to become vulcanised by the time it emerges from the left-hand, outlet end of the forming section. This treatment time can be achieved by arranging for the tubing to be extruded at a relatively slow rate and for a relatively short chain of the mold blocks 132 to move slowly around the trackways 130 and 131, or, the forming section could be lengthened by using additional or longer mold blocks so that a faster speed can be achieved. As the corrugated tubing 102′ emerges from the forming section 133 its temperature falls to room temperature. The corrugated tubing 102′ can then be cut to any desired length.

What I claim is:

1. Apparatus for vulcanising uncured tubing of a rubber material comprising: an external mold arrangement, said mold arrangement having a surface for contacting an external surface of said tubing; an arrangement for forcing the tubing into contact with said surface of said mold arrangement; and a heater for heating said mold arrangement such that said tubing is heated while in contact with said mold arrangement for sufficient time for the rubber material of said tubing to vulcanise.

2. Apparatus according to claim 1, wherein said surface of said mold arrangement is provided with surface formations corresponding to an external shape of surface formations to be formed on said tubing.

3. Apparatus according to claim 2, wherein said surface formations on said mold arrangement are corrugations such that said tubing is formed with a corrugated shape.

4. Apparatus according to claim 1, wherein the arrangement for forcing said tubing into contact with said surface of said mold includes a source of gas pressure.

5. Apparatus according to claim 4, wherein the source of gas pressure is a source of negative pressure connected to supply a negative pressure outside said tubing.

6. Apparatus according to claim 4, wherein the source of gas pressure is a source of positive pressure connected to supply a positive pressure inside said tubing.

7. Apparatus according to claim 1, wherein said heater includes an electrical resistance heating element associated with said mold arrangement.

8. Apparatus according to claim 1, wherein the apparatus includes an arrangement for displacing said uncured rubber tubing along its length and wherein said mold arrangement is provided by a plurality of molds arranged in a continuous loop that is movable with said tubing as it is displaced.

9. Apparatus according to claim 8, wherein the arrangement for displacing said tubing is an extruder.

10. Apparatus for vulcanising uncured tubing of a rubber material comprising: a plurality of external mold parts, said mold parts having surface formations for contacting an external surface of said tubing; a gas pressure arrangement for forcing the tubing into contact with said surface formations; and a heater for heating said mold parts such that said tubing is heated while in contact with said mold parts for sufficient time for the rubber material of said tubing to vulcanise and for said external surface of said tubing to take the shape of said surface formations.

11. A method of making tubing of a rubber material comprising the steps of: providing smooth-walled tubing of an uncured rubber material; contacting an external surface of said tubing with a mold surface; heating said tubing while it is contacted by said mold surface; maintaining said tubing at a sufficient temperature and maintaining contact with said mold surface for a sufficient time that said tubing becomes vulcanised.

12. A method according to claim 11, wherein said mold surface is profiled and an external surface of said tubing is forced into contact with the profiled mold surface such that said tubing takes the shape of said mold surface.

13. A method according to claim 11, including the step of applying gas pressure to force said external surface of said tubing into contact with said mold surface.

14. A method according to claim 11, including the step of moving said tubing along its length as it is vulcanised.

15. A method of making tubing of a rubber material comprising the steps of: locating smooth-walled tubing of an uncured rubber material in a mold, said mold having a profiled inner surface; applying gas pressure to expand said tubing to contact an external surface of said profiled mold surface; heating said mold thereby to heat said tubing while it is in contact with said mold surface; and maintaining said tubing at a sufficient temperature and maintaining contact with said mold surface for a sufficient time that said tubing becomes vulcanised and takes an external shape corresponding to the profiled inner surface of the mold.
